(19) United States
(12) Patent Application Publication
(10) Pub. No.: US 2016/0019542 A1
(43) Pub. Date: Jan. 21, 2016

(54) Method For Providing Secure E-Commerce Transactions

(71) Applicant: S.A. SELINKO, Biez (DE)

(72) Inventor: Patrick Eischen, Biez (BE)

(73) Assignee: S. A. Selinko, Biez (BE)

(21) Appl. No.: 14/772,074

(22) PCT Filed: Jun. 13, 2013
(86) PCT No.: PCT/EP2013/001747

§ 371 Date: Sep. 2, 2015

(30) Foreign Application Priority Data
Mar. 4, 2013 (EP) 13157689.4

(51) Int. Cl. G06Q 20/38; G06Q 20/40

(52) U.S. Cl. CPC G06Q 20/38215; G06Q 20/405

(57) ABSTRACT

Method for providing e-Commerce secure transactions through a computer network comprising the steps of generating an encrypted digital object certificate for an object; generating an encrypted digital seller certificate for a seller of said object; assigning an active or a suspended or a revoked status to said object certificate according to first predetermined criteria; assigning an active or a suspended or a revoked status to said seller certificate according to second predetermined criteria. The method further comprises the steps of generating an encrypted digital sale certificate by means of aggregating elements comprising said object certificate and said seller certificate; assigning by said online sales certified actors authority a revoked status to said sale certificate if the status of said seller certificate and of said object certificate are not both active and an active status otherwise; publishing said sale certificate and/or its status in said online shop. Thanks to the invention, sale certificates in a plurality of online shops can be simultaneously revoked if a seller certificate or an object certificate is revoked

### BACKGROUND OF THE INVENTION

1. Field of the Invention

The present invention relates to methods for providing secure e-commerce transactions.

Different methods exist for providing secure e-commerce transactions and in particular for preventing the sale and the purchase of fake and counterfeited objects, especially in online shops having websites proposing objects for sale and to which potential purchasers do access through a computers network such as the Internet, from their personal computers or other digital devices such as smartphones or tablets having a wired or wireless connection with the said network. Such methods generally comprise the step of securing the objects to be sold online by means of encrypted digital certificates based on PKI (public key infrastructure) technology (i.e. exchange of asymmetric keys) or other equivalent/alternative encrypting technologies known in the art.

2. Background Art

For example, the patent application US 2011/0191590 A1, incorporated herewith in its entirety by reference, describes a method for digital authentication of objects, in which a storage device is appended to an object, this storage device including a digital certificate of authenticity issued by a certification authority and having encrypted therein information on the object, the validity of the digital certificate being verifiable by a validating or the certification authority having issued the certificate, through a network computer cooperating with the storage device and the validating or the certification authority. This validity check is performed by receiving information on the status of the object by the certification authority, creating an entry corresponding to this status in a database and reading this entry by the validating or the certification authority.

Another prior art technology is described by the patent application FR 2847053 A1 also incorporated herewith in its entirety by reference and which relates to an e-commerce method in which an object is offered for sale and a descriptive file of the object for sale is placed in a database and transmitted via the Internet to a central system which transmits an authenticity certificate in response. A purchaser transmits search criteria to a central search engine which transmits a list of corresponding object identifiers. During a transaction phase the purchaser transmits an object identifier to a supplier who transmits an object description file and associated authenticity certificate in order for the purchaser to be sure to buy an authenticated object.

On the other hand, secure online payment methods through a computer network such as the Internet do exist, like for example that developed by the Paypal Inc. company as notably described in the U.S. Pat. No. 7,089,208 B1 which is incorporated herewith by reference in its entirety. According to the described method, the purchaser of an object on an online shop, such as an auction website like for example the website run by the ebay company, not only is able to securely pay to a seller a sold object but is also enabled to identify this seller by receiving its identity and location details in order to trace this seller if the sold object is fake, does not correspond to its description in the online shop or is not sent by the seller and in such a situation, to possibly cancel the payment of said object.

The combination of the above technologies, i.e. securing the authentication of an object for sale in an online shop such as an auction website thanks to a digital certificate appended to this object, securing the payment of this object thanks to secure online payment methods and securing the identity of a seller of such an object in an online shop in order for a buyer to be able to trace the said seller and possibly to cancel the online payment of the considered object if e.g. the sold object is not ship to the buyer provide a certain degree of certainty and security to e-commerce transaction but is however problematic.

Indeed, the potential buyer of an object in an online shop such as an auction website is not aware before its purchase of whether or not the sale transaction which he is about to enter into is secure or not, i.e. whether or not both the object for sale is authentic and the seller is a secure seller, i.e. a seller who is not inclined notably not to ship the objects he proposes for sale in the considered online shop. Besides, if the same object is proposed by the same seller in different online shops such as auction websites, even if a non secure seller would have been banned from one of these online shops thanks to an internal policy of this online shop, there is no possibility for a buyer to be aware of this if he purchases the considered object in another online shop

### SUMMARY OF THE INVENTION

The present invention solves these problems by offering a method for providing e-Commerce secure transactions through a computer network comprising the steps of generating an encrypted digital object certificate for an object by an object certification authority or by an online sales certified actors authority, and associating or appending this certificate to said object or storing it in a database, generating an encrypted digital seller certificate for a seller of said object by a seller certification authority or by said online sales certified actors authority and storing this certificate in a database, assigning by said object certification authority or by said online sales certified actors authority an active or a suspended or a revoked status to said object certificate according to first predetermined criteria and storing this status in a database; assigning by said seller certification authority or by said online sales certified actors authority an active or a suspended or a revoked status to said seller certificate according to second predetermined criteria and storing this status in a database, the method according to the invention further comprising the steps of accessing by said online sales certified actors authority through the computer network said object certificate and said seller certificate; generating an encrypted digital sale certificate by said online sales certified actors authority by means of aggregating elements comprising said object certificate and said seller certificate and storing this certificate in a database; accessing by said online sales certified actors authority through the computer network the status of said object certificate and the status of said seller certificate; assigning by said online sales certified actors authority a revoked status to said sale certificate if the status of said seller certificate and of said object certificate are not both active and an active status otherwise and storing this status in a database, accessing by said online shop through said computer network the status of said sale certificate and publishing said sale certificate and/or its status in said online shop. Thanks to the fact that the claimed method comprises the steps of accessing by said online sales certified actors authority through the computer network said object certificate and said seller certificate, generating an encrypted digital sale certificate by said online sales certified actors authority by means of aggregating elements comprising said object certificate and said seller certificate and storing this certificate in a database, accessing by said online sales certified actors authority through the computer network the status of said object certificate and the status of said seller certificate; assigning by said online sales certified actors authority a revoked status to said sale certificate if the status of said seller certificate and of said object certificate are not both active and an active status otherwise and storing this status in a database, accessing by said online shop through said computer network the status of said sale certificate and publishing said sale certificate and/or its status in said online shop, it is possible for a potential buyer of such an object which is offered for sale in several online shops by a same seller, to verify through the status of the sale certificate published in these different online shops whether or not the e-commerce transaction into which this buyer is about to enter is secure and if not, to avoid entering this transaction. Indeed, if the seller certificate of a seller offering for sale an object in different online shops has a revoked status and/or the object certificate of said object has a revoked status, the sale certificate associated to this seller and this object will also have a revoked status in each of the considered online shops, even if this seller certificate itself is different for each of said online shops. The invention therefore enables to simultaneously revoke sale certificates generated for a same seller and a same object throughout a plurality of online shops, by the revocation of the considered object and/or of the seller certificate. The expression “revocation of a certificate” means that the status of this certificate is a revoked status.

According to the invention, to secure a sales process, different entities involved in online sales transactions (i.e. the objects, the sellers, the buyers, the online shops, the brands of the objects) may receive their own unique encrypted digital certificate. These certificates are respectively generated by specific certification authorities (as defined in the standard PKI Terminology), i.e. object certificate authorities, seller certificate authorities, online shop certificate authorities, buyer certificate authorities, brand certificate authorities. These authorities are connected to an authority called online sales certified actors (OSCA), which is an organization independent from the actors of sale transactions. Alternatively, the functions of one or a plurality of said certificate authorities can be performed by the OSCA itself. The OSCA authority and/or the certification authorities, depending on which authority generates a certificate, define predetermined criteria consisting notably in the policies and the governance to be respected by the entities involved in a sale transaction in order to receive certificates. According to such criteria, the status of the corresponding certificates is defined as active, suspended or revoked. Each authority (i.e. the OSCA authority and/or the certification authorities) manages a database storing the certificates it has generated and the status of these certificates or a different database for storing these certificates and their respective status. The OSCA and/or the certification authorities also enable the access to these databases by the appropriate entities involved in sales process, notably in order to check the status of the different certificates.

The generation by an object certificate authority (OCA) or alternatively by the OSCA of an encrypted digital object certificate is performed according to the invention through the following process:

A brand owner, a manufacturer or a distributor decides to protect objects to be sold from counterfeiting by associating to each of these object an encrypted digital certificate containing information regarding the details of the object. This certificate can notably be stored in a chip on each object, or on a chip stored on a card associated to the object by a serial number for example. It can also be a certificate stored in a database and associated to a unique physical identifier of the object (hologram, unique visual code . . . ). In order to generate object certificates, the brand owner, manufacturer or distributor needs to use an Object Certificate Authority for generating the certificates for its objects. This OCA can be managed by the brand owner, manufacturer or distributor itself, or managed by an independent entity as notably a global certificate authority (e.g. Globalsign, Verisign) or by the OSCA.

The generation by a seller certificate authority (SCO) or alternatively by the OSCA of an encrypted digital seller certificate is performed according to the invention through the following process:

A seller wishing to sell a certified Object is provided according to the invention with a digital encrypted seller certificate comprising information relating to the seller details, which will be generated by a seller certificate authority or alternatively by the OSCA. The SCA delivers certificates based on an agreement that the seller follows certain rules and policies intended notably e.g. to prevent the sale of fake and counterfeited objects and to ship the objects sold. If the seller does not respect the rules and policies of the SCA, the SCA can revoke the seller certificate, i.e. the status of the certificate is changed from active” to “revoked” or if the behaviour of the seller is still to be evaluated, possibly to “suspended”. The seller certificate can also be attributed by the SCA based on existing validation of the seller credentials through online shops on which the seller is already existing and trusted or certified (for example a validated Paypal account owner seller, a trusted Amazon account, a valid credit card etc. . . . . It can also be a certificate tied to an electronic identity card.

### BRIEF DESCRIPTION OF THE DRAWINGS

The method according to the invention will now be described in further details through a non-limitative example of embodiment of this method and with reference for certain of the its steps to the enclosed figures, in which

FIG. 1 is a schematic view of elements of a system implementing the method according to the invention;

FIGS. 2a and 2b is a flowchart of certain steps of an embodiment of the method according to the invention involved in the generation of a sale certificate;

FIGS. 3a and 3b is a flowchart of other steps of the considered embodiment of the method according to the invention involved in the generation of a purchase certificate;

### DETAILED DESCRIPTION

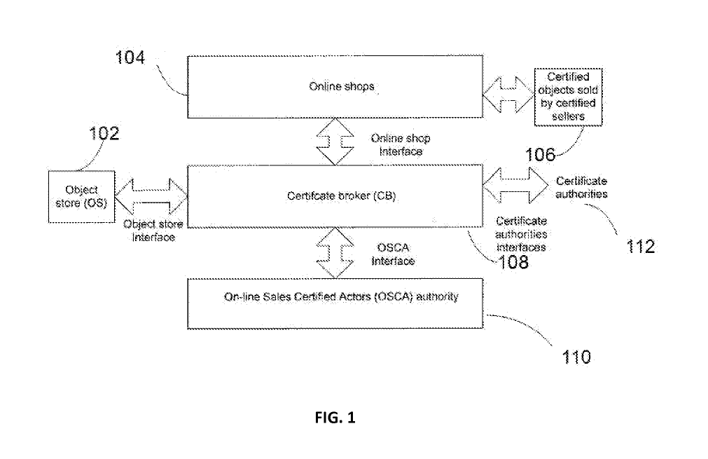

Referring to FIG. 1, a system is illustrated which is able to implement the method according to the invention. The illustrated system comprises online shops, certified objects to be sold in said online shops by certified sellers, these objects having been certified by an object certificate authority (OCA) and these sellers having been certified by a seller certificate authority (SCA), an object store (OS) which is a database in which characteristics of the objects to be sold are stored and can be retrieved thanks to the unique certificate of this object, to which the said characteristics are associated in the object store, an online sale certificate actors (OSCA) authority and certificate authorities respectively arranged for generating digital encrypted certificates to sellers, online shops, brands of objects and buyers if the latter satisfy respective predetermined criteria.

The connections between the online shops, the certified authorities and/or the OSCA, and the object store, as represented in FIG. 1 are performed through a certificate broker (CB) to which the said elements are connected through a computer network such as the Internet, by means of dedicated interfaces. Alternatively, the connections with the certified broker and the certificate authorities can be performed through the OSCA authority.

The certificate broker is a middleware entity that routes the requests coming from the on-line shops to the certificate authorities and/or the OSCA, and routes back the responses to the on-line shops. To achieve its role it is provided with an interface with each on-line shop through the computer network. The certificate broker comprises a registry with the addresses of the certificate authorities and/or of the OSCA and is provided with interfaces with the certificate authorities and/or to the OSCA through the computer network. If no certificate does exist corresponding to the request, no authorities having generated such certificates are found and the certified broker notifies this to the online shop which regards this notification as equivalent to a that of a certificate having a non active status.

In the exemplified embodiment of the method for providing e-Commerce secure transactions through a computer network according to the present invention this method comprises in a first sequence (not illustrated), the generation of an encrypted digital object certificate for an object to be sold by an object certification authority or by an online sales certified actors authority and association or appendence of this certificate to said object or the storing of this certificate in a database; the generation of an encrypted digital seller certificate for the seller of said object by a seller certification authority or by said online sales certified actors authority and the storage of this certificate in a database of the authority having generated the considered certificate; the assignment by said object certification authority or by said online sales certified actors authority of an active or a suspended or a revoked status to said object certificate according to first predetermined criteria and the storage of this status in a database of the considered authority; the assignment by said seller certification authority or by said online sales certified actors authority of an active or a suspended or a revoked status to said seller certificate according to second predetermined criteria and the storage of this status in a database of the authority having assigned said status.

The considered first sequence further comprises the generation for the online shop in which said object is sold of a digital encrypted online shop certificate by an online shop certificate authority or by the online sales certified actors authority and the storage of this certificate in a database of the authority having generated said certificate; the assignment by the online shop certificate authority or by the online sales certified actors authority of an active or a suspended or a revoked status to said online shop certificate according to third predetermined criteria and the storage of this status in a database of the authority having assigned said status.

The online shop certificate authority (OShCA) is an entity which is independent with regard to the online shops and has the objective of contributing to secure sales by online shops. The online shop certificate authority delivers a certificate to a requesting online shop based on an agreement by the on-line shop to follow certain rules and policies notably intended to prevent the sale of fake and counterfeited objects in their shop. If the on-line shop does not respect these rules and policies, the OShCA can suspend or revoke the online shop certificate (i.e. its status is changed from valid to suspended or revoked or conversely).

The above first sequence comprises in addition the generation for the brand of the object to be sold of a digital encrypted brand certificate by a brand certificate authority or by said online sales certified actors authority and the storage of this certificate in a database of the authority having generated the certificate; the assignment by said brand certificate authority or by said online sales certified actors authority of an active or a suspended or a revoked status to said brand certificate according to fourth predetermined criteria and the storage of this status in a database of the authority having assigned said status;

A brand certificate authority (BCA) is an entity which is independent with regard to the brands and has the objective of contributing to secure sales of branded objects, especially in online shops. The brand certificate authority delivers a certificate to a requesting brand based on an agreement that the brand will follow certain rules and policies intended to contribute in the prevention of sales of fake and counterfeited objects. If the brand does not respect the rules and policies of the brand certificate authority, the BCA can revoke the brand certificate.

The first sequence also comprise the steps of storing details regarding the object to be sold in an object store, as here above defined with reference to FIG. 1.

The same first sequence furthermore comprises the generation of a digital encrypted buyer certificate by a buyer certificate authority or by the online sales certified actors authority and the storage this certificate in an database of the authority having generated this certificate; the assignment by said buyer certificate authority or by the online sales certified actors authority of an active or a suspended or a revoked status to this certificate according to fifth predetermined criteria and the storage of this status a database of the authority having assigned said status;

A buyer certificate authority (BuCA) is an entity which is independent with regard to buyers and has the objective of contributing to secure sales by online shops. The buyer certificate authority delivers a certificate to a requesting buyer based on an agreement by the buyer to follow certain rules and policies notably intended to prevent the sale of fake and counterfeited objects in online shops. If the buyer does not respect these rules and policies, the BuCA can suspend or revoke the buyer certificate (i.e. its status is changed from valid to suspended or revoked).

A buyer certificate can alternatively be attributed by the BuCA based on existing certification of the buyer, e.g. a validated Paypal account, a trusted Amazon account, a valid credit card or an electronic identity card of this buyer.

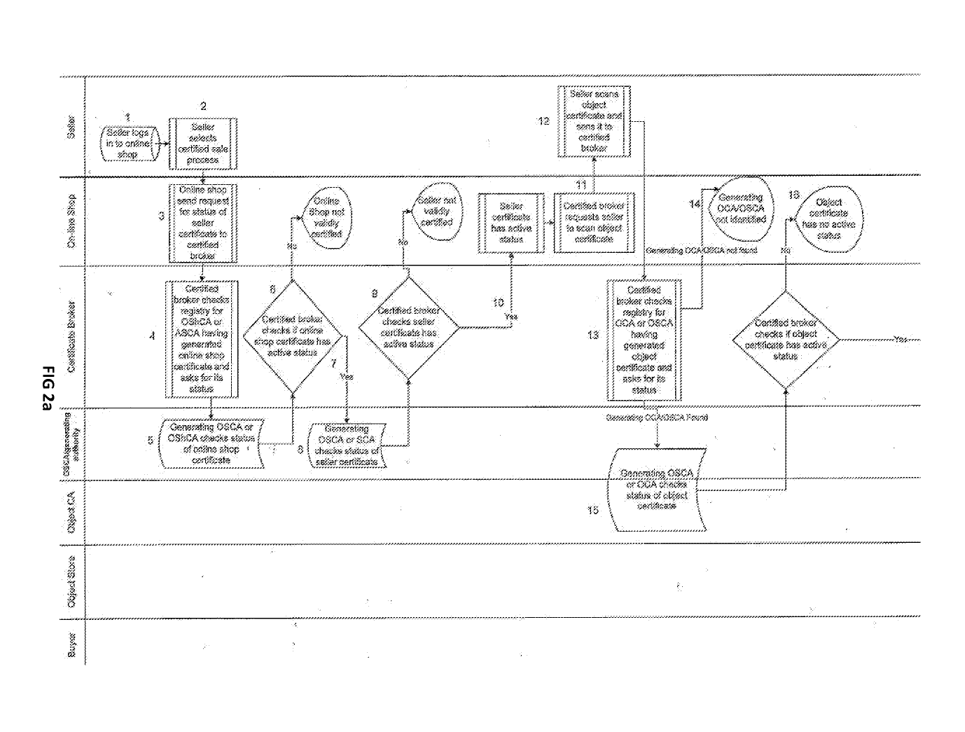

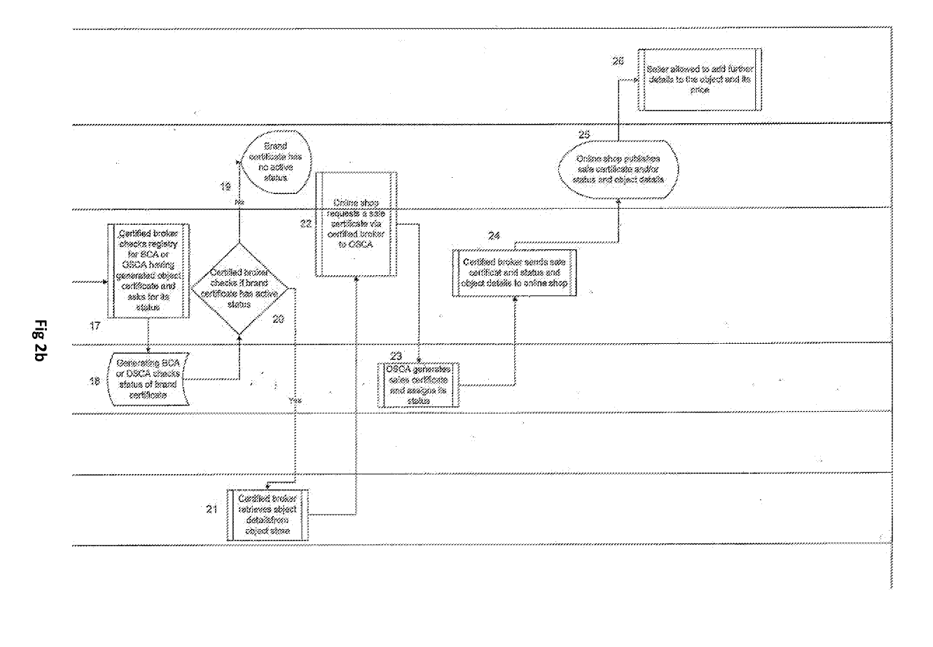

Referring to FIG. 2a and FIG. 2b, a second sequence of a method according to the exemplified embodiment of the invention is illustrated in which a seller wishes to sale an object having a brand in an online shop. The seller logs in to the online shop by means of his account with this shop 1. He then selects in an online shop webpage an option mentioning “Sell object through a certified sale process” 2. The online shop then sends a request for the status of the seller certificate to a certified broker by sending the references of this certificate (i.e. a numeric key assigned to the certificate) to the certified broker. The latter upon reception of the request checks its registry based on the received references of said certificate to identify the appropriate seller certificate authority having generated the considered seller certificate or the appropriate OSCA authority if the latter has generated said seller certificate 3. The certified broker verifies based on the references of the online shop such as its Internet address if the request comes from a certified online shop which has a certificate whose status is active by identifying in its registry which online shop certificate authority has generated the online shop certificate or whether it has been generated by the OSCA authority and asks the appropriate authority to check the status of the online shop certificate and forward it to the certified broker which 4. The OSCA authority or the online shop certificate authority having generates the online shop certificate checks the status of this certificate 5. The certified broker checks the received status and if the online shop certificate has not an active status, this certified broker forwards this response to the online shop specifying that is not validly certified for entering into a secure sale process 6. If the online shop certificate has an active status, the certified broker sends the request for the status of the seller certificate to the OSCA authority or to the seller certificate authority according to which one of these authorities has generated the seller certificate of the considered seller 7.

The OSCA authority or the certificate seller authority then verifies whether the status of the seller certificate is active or not and sends the result back to the certified broker, i.e. the references of the certificate and its status 8. The latter then checks if the seller certificate is active and if not, it sends a message back to the online shop specifying that the seller is not validly certified for entering into a secure sale transaction 9. If the seller certificate has an active status, the certified broker sends a message back to the online shop specifying that the seller has a certificate having an active status and what are the references of this certificate 10.

Afterwards, the online shop requests the seller to scan the certificate of the object to be sold or to retrieve this certificate in the database in which it was stored if so. This can be done e.g. by reading the object certificate appended to the object with a computer, tablet or mobile device of the seller (with a near field communication (NFC) technology or any other technology giving access to the digital certificate associated to the object) 11. The obtained object certificate references are then sent by the online shop to the certified broker 12. The latter checks these references and determines in its registry by which object certificate authority it has been generated or if this generation has been performed by the OSCA authority. This can be done by questioning all the object certificate authorities and/or the OSCA authority with the object certificate references and evaluating the answers, by using a specific routing protocol such as a server based validation protocol (SCVP), or by obtaining sufficient information through the reading of the object certificate to determine which authority has generated this certificate 13. Since the possible brand of the object is part of the information provided by its certificate, the identification of the authority having generated the object certificate by means of the references of this certificate also enables to determine which brand certificate authority has generated the brand certificate to the brand of the object or whether this generation has been performed by the OSCA authority. If it cannot find the relevant object certificate authority or determine that the OSCA authority has generated the object certificate, the certified broker sends a message back to the online shop reflecting this impossibility 14. If the considered object certificate or OSCA authority is found by the certified broker, he sends the object certificate references to the found authority which checks if its status is active, suspended or revoked 15. If this status is not active, the certified broker sends a message back to the online shop specifying this 16.

If thanks to the object certificate references the certified broker determines that the considered object is branded, it connects itself through the computer network by means of a dedicated interface to the brand certificate authority having generated the considered certificate or to the OSCA authority if the latter has generated said certificate and asks for the status of the brand certificate of the brand of the object 17. The relevant authority then verifies if the brand certificate has an active status and sends the response back to the certified broker (18). If the brand certificate has an active status, the certified broker sends this information back to the online shop (19). If the status of the object certificate is active, the certified broker connects itself to the object store through the computer network by means of a dedicated interface and requests details on this object stored in said object store, thanks to the object certificate references, which in the object store is associated to the considered details 20. The object store sends back to the certified broker the considered details (e.g. brand, model, serial, colour, . . . ) 21. The online shop via the certified broker requests a sale certificate for the sale by the considered seller of the considered object having the considered brand in the considered online shop to the OSCA authority 22.

The latter then accesses the object certificate, the seller certificate, the online shop certificate and the brand certificate through the computer network by means of dedicated interfaces with the authorities having generated the considered certificates if they have not been generated by the OSCA authority itself;

The second sequence of the illustrated method according to the invention in addition comprises the generation of an encrypted digital sale certificate by the OSCA authority by means of aggregating elements comprising said object certificate, said seller certificate, said online shop certificate, said brand certificate and the storage of this sale certificate in a database of the OSCA authority; the accession by said online sales certified actors authority through the computer network to the status of said object certificate, of said seller certificate, of said online shop certificate and of said brand certificate; assignment by said online sales certified actors authority of a revoked status to said sale certificate if the status of said seller certificate, of said object certificate, of said online shop certificate and of brand certificate are not both active and the assignment of an active status to said sale certificate otherwise; as well as the storage of this status in a database of said OSCA authority; the accession by said online shop through said computer network of this status and the publication of said sale certificate and/or of its status in said online shop 23; the assignment by said online sales certified actors authority of a first timestamp to said sale certificate and the revocation of the sale certificate if said timestamp is lapsed (not illustrated). Typically, this timestamp is the duration of the sale (e.g. 3 to 15 days) as determined by the seller, or a duration agreed between the OSCA authority and the online shop.

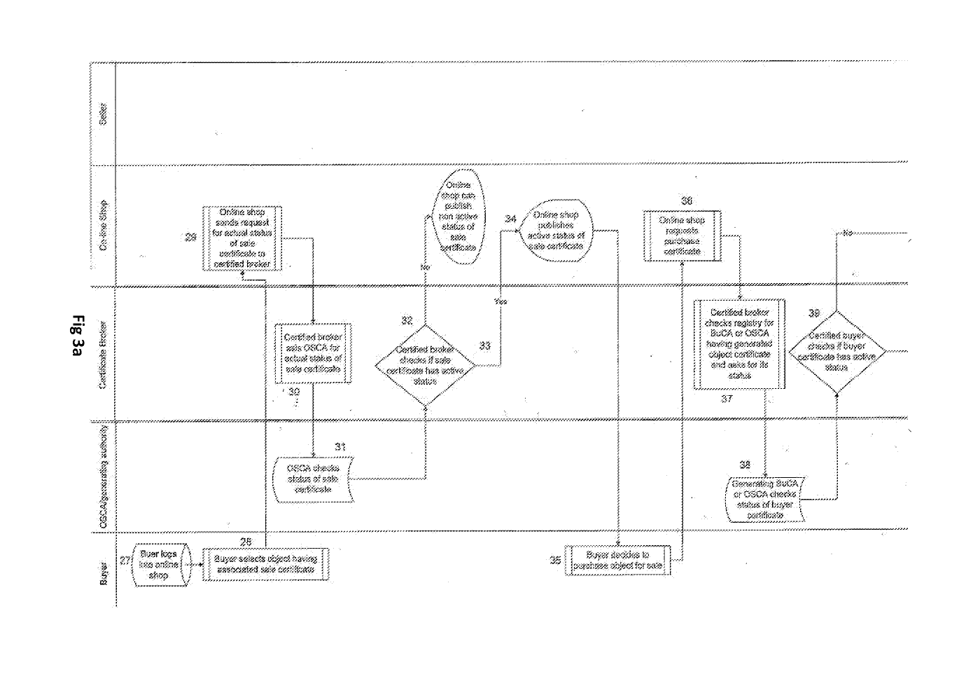

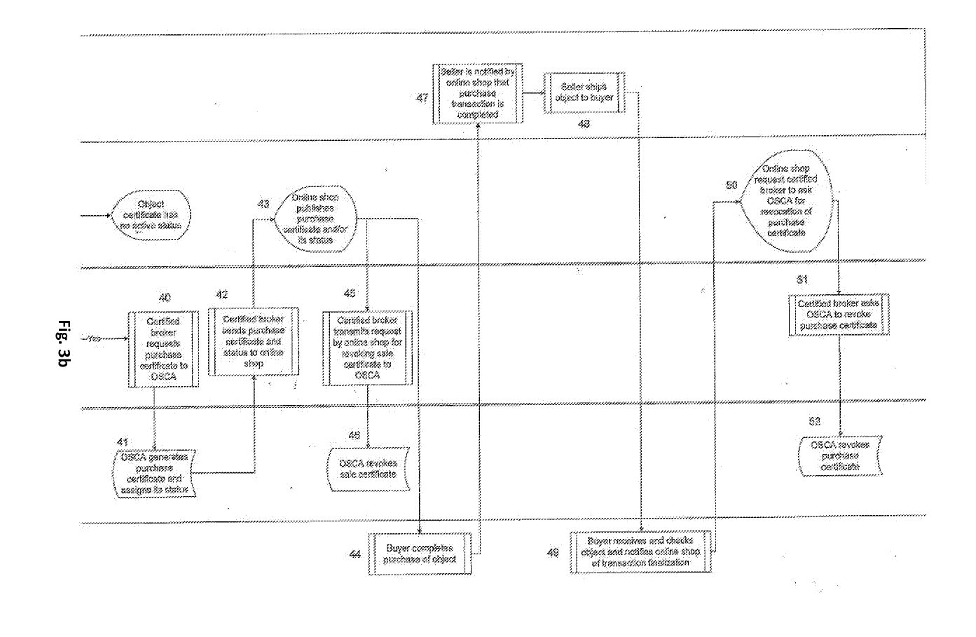

Once the sale certificate is generated, it is passed by the OSCA authority to the certified broker which sends it and the object details to the online shop 24. The latter then publishes the sale certificate as well as its status and the object details 25. The seller is then allowed to add additional details to the object details published in the online shop as well as the price of the object (26). Referring to FIG. 3a and FIG. 3b, a third sequence of the exemplified embodiment of a method according to the invention is illustrated in which a certified buyer wishes to purchase a certified object in a certified online shop. The buyer therefore logs in to the online shop 27. He then selects an object to which a sale certificate is associated 28. The online shop can either only sell objects having associated sale certificates, or can have a specific section or visual presentation for such objects.

When an object is selected, to which a sale certificate is associated, the online shop sends a request for checking the actual status of this sale certificate to the certified broker 29. The latter sends this request to the OSCA authority 30. This authority thus verifies the considered actual status and passes the response to the certified broker 31. The Certified broker checks this response and if the sale certificate has not an active status, sends a negative response to the online shop 32. Conversely, if the sale certificate has an active status, this information is sent back to the online shop, which can publish this information 33 and the latter publishes the actual status of the sale certificate 34. The buyer is therefore able to see that the sale certificate is active and to decide to purchase the object for sale 35. The online shop then issues a purchase certificate request and sends it to the certified broker 36 which in turn checks its registry by means of the buyer certificate references for determining the buyer certificate authority or OSCA authority having generated this certificate and asks for the status of this certificate to the determined authority 37. The latter checks the status of the buyer certificate and forward it to the certified broker 38. The latter checks if the certificate has an active status or not and if not notifies this to the online shop which means that no purchase certificate can be issued 39. If on the contrary the status of the buyer certificate is active, the certified broker requests a purchase certificate from the OSCA authority 40. The OSCA authority then accesses through the computer network the sale certificate and said buyer certificate, generates an encrypted digital purchase certificate by aggregating said sale certificate and said buyer certificate, stores this buyer certificate in a database of the OSCA authority and assigns an active status to this purchase certificate if the status of the sale certificate and of the buyer certificate are both active and a revoked status otherwise 41. The OSCA authority subsequently assigns a second timestamp to the purchase certificate, typically the time needed for the transaction to be completed (validation of the purchase of the object for sale by the buyer, e.g. by completion by the latter of the payment of this object) (not illustrated). The OSCA authority revokes the purchase certificate if this timestamp is lapsed, i.e. if the purchase of the object is not completed by the buyer before the lapse of said timestamp.

Once the purchase certificate is generated and its status assigned by the OSCA authority, the certified broker sends this purchase certificate and/or its status to the online shop 42 and said purchase certificate and/or its status is/are published in said online shop 43. The buyer then completes the purchase of the object 44. The online shop then requests the certified broker to ask the revocation of the sale certificate by the OSCA authority 45 and the latter accordingly revokes this certificate 46. Afterwards, the seller receives a notification from the online shop according to which the purchase transaction completed 47 and he then ships the object to the buyer 48.

When the buyer receives the object sold, he verifies by reading the content of the object certificate that this object is authentic and corresponds to its details as published in the online shop. If the money paid for completing the transaction was stored on an escrow account, the verification by the buyer of the authenticity and accuracy of the object sold can free up the money transaction so that the seller can be paid 49 and notifies the online shop of this. The online shop is then notified by the certified broker by means of the references of the buyer certificate and an information indicating that the transaction is finalized that this is so and requests the certified broker to ask the OSCA authority to revoke the purchase certificate (50). The certified broker thus sends this request to the OSCA authority 51 which accordingly revokes the purchase certificate 52.

1. Method for providing e-Commerce secure transactions for an object by a system through a computer network, said system comprising an object certificate authority, a seller certificate authority and/or an online sales certified actors authority and an online shop, the method comprising the steps of:
generating an encrypted digital object certificate for said object by the object certificate authority or by the online sales certified actors authority and associating or appending this certificate to said object or storing this certificate in a database;
generating an encrypted digital seller certificate for a seller of said object by the seller certificate authority or by said online sales certified actors authority and storing this certificate in a database;
assigning by said object certification authority or by said online sales certified actors authority an active or a suspended or a revoked status to said object certificate according to first predetermined criteria and storing this status in a database;
assigning by said seller certification authority or by said online sales certified actors authority an active or a suspended or a revoked status to said seller certificate according to second predetermined criteria and storing this status in a database;
accessing by said online sales certified actors authority through the computer network said object certificate and said seller certificate;
generating an encrypted digital sale certificate by said online sales certified actors authority by means of aggregating elements comprising said object certificate and said seller certificate and storing this certificate in a database;
accessing by said online sales certified actors authority through the computer network the status of said object certificate and the status of said seller certificate;
assigning by said online sales certified actors authority a revoked status to said sale certificate if the status of said seller certificate and of said object certificate are not both active and an active status otherwise and storing this status in a database;
accessing by said online shop through said computer network the status of said sale certificate; and
publishing said sale certificate and/or its status in said online shop

2. Method according to claim 1, characterized in that it further comprises the step of:
assigning by said online sales certified actors authority a first timestamp to said sale certificate and revoking the sale certificate if said timestamp is lapsed.

3: Method according to claim 1, said system further comprising an online shop certificate authority, characterized in that the method further comprises the steps of:
generating for said online shop a digital encrypted online shop certificate by the online shop certificate authority or by said online sales certified actors authority and storing this certificate in a database;
assigning by said online shop certificate authority or by said online sales certified actors authority an active or a suspended or a revoked status to said online shop certificate according to third predetermined criteria and storing this status in a database;
in that said elements comprise said online shop certificate and in that said method further comprises the steps of accessing through the computer network by said online shop certificate authority or by said online sales certified actors authority the status of said online shop certificate;
assigning by said online shop certificate authority or by said online sales certified actors authority a revoked status to said sale certificate if the status of said online shop certificate is revoked.

4: Method according to claim 1, said system further comprising a brand certificate authority, characterized in that the method further comprises the steps of:
generating for the brand of the object to be sold a digital encrypted brand certificate by the brand certificate authority or by said online sales certified actors authority and storing this certificate in a database;
assigning by said brand certificate authority or by said online sales certified actors authority an active or a suspended or a revoked status to said brand certificate according to fourth predetermined criteria and storing this status in a database;
accessing through the computer network by said brand certificate authority or by said online sales certified actors authority the status of said brand certificate; and
assigning by said brand certificate authority or by said online sales certified actors authority a revoked status to said sale certificate if the status of said brand certificate is revoked.

5: Method according to claim 1, said system further comprising an object store, characterized in that the method further comprises the steps of:
storing details regarding said object in the object store;
accessing these details by said online shop through said computer network by means of said object certificate;
publishing said details in said online shop.

6: Method according to claim 1, said system further comprising a buyer certificate authority, characterized in that the method further comprises the steps of:
generating for a buyer of said object a digital encrypted buyer certificate by the buyer certificate authority or by said online sales certified actors authority and storing this certificate in a database;
assigning by said buyer certificate authority or by said online sales certified actors authority an active or a suspended or a revoked status to this certificate according to fifth predetermined criteria and storing this status in a database;
accessing by said online sales certified actors authority through the computer network said sale certificate and said buyer certificate; generating by said online sales certified actors authority an encrypted digital purchase certificate by aggregating said sale certificate and said buyer certificate and storing this buyer certificate in a database;
assigning by said online sales certified actors authority an active status to said purchase certificate if the status of said sale certificate and of said buyer certificate are both active and a revoked status otherwise; publishing said purchase certificate and/or its status in said online shop.

7. (canceled)

8. (canceled)

9: A system for implementing a method for providing e-Commerce secure transactions for an object by a system through a computer network, the system comprising:
an object certificate authority arranged for generating an encrypted digital object certificate for an object and for assigning an active or a suspended or a revoked status to said object certificate according to first predetermined criteria and storing this status in a database,
a seller certificate authority and a corresponding database, said seller certificate authority being arranged for generating an encrypted digital seller certificate for a seller and for assigning an active or a suspended or a revoked status to said seller certificate according to second predetermined criteria and storing this status in a database and/or an online sales certified actors authority, said online sales certified actors authority being arranged for generating said object and/or said seller certificate, for assigning said status to said object and/or to said seller certificate and for storing said status in a database, characterized in that the system further comprises a certified broker and an online shop,
the certified broker being connected to said online shop through a computer network by means of a dedicated interface and with said object certificate authority and/or to said seller certificate authority through said computer network by means of interfaces respectively dedicated to each of said authorities, said certified broker being arranged for transmitting a request by said online shop to said online sales certified actors authority for generating by the latter an encrypted digital sale certificate by means of aggregating elements comprising said object certificate and said seller certificate and storing said seller certificate in the corresponding database and assigning by said online sales certified actors authority a revoked status to said sale certificate if the status of said seller certificate and of said object certificate are not both active and an active status otherwise and storing this certificate in a database.
